(19) United States
(12) Patent Application Publication
(10) Pub. No.: US 2025/0370186 A1
(43) Pub. Date: Dec. 4, 2025

(54) OPTICAL WAVEGUIDE CONNECTION STRUCTURE

(71) Applicant: Nippon Telegraph and Telephone Corporation, Tokyo (JP)

(72) Inventors: Yoshie Morimoto, Musashino-shi, Tokyo (JP); Kenya Suzuki, Musashino-shi, Tokyo (JP); Osamu Moriwaki, Musashino-shi, Tokyo (JP)

(21) Appl. No.: 18/874,521

(22) PCT Filed: Jun. 15, 2022
(86) PCT No.: PCT/JP2022/024012

§ 371 Date: Dec. 12, 2024

(51) Int. Cl. G02B 6/122; G02B 6/12

(52) U.S. Cl. CPC G02B 6/1228; G02B 2006/12038; G02B 2006/12061

(57) ABSTRACT

An optical waveguide connection structure which connects a silicon optical waveguide and an SiO₂ optical waveguide is constituted by an under-clad layer formed on an upper surface of a support substrate; a ridge structure formed on an upper surface of the under-clad layer; a silicon core being in contact with the ridge structure; a pattern structure which is in contact with the silicon core, has a shape and a size coincident to the silicon core in a top view, and has a refractive index lower than that of the silicon core; an SiO₂ core which covers the ridge structure, the pattern structure and the silicon core, and has a refractive index lower than the silicon core and higher than the under-clad-layer; and an over-clad layer which is in contact with the SiO₂ core and has a refractive index lower than that of the SiO₂ core.

### TECHNICAL FIELD

The present disclosure relates to a connection structure of an optical waveguide.

### BACKGROUND ART

In recent years, with an increase in traffic of communication in a data center, the importance of optical wiring technology for elements in a computer housing has increased, and particularly, silicon photonics technology capable of integrating a large number of optical circuits with high density has been attracting attention. The silicon photonics circuit functions as an optical transmission medium in silicon photonics technology. The silicon photonics circuit is constituted by a silicon thin wire waveguide having a core made of Si and a cladding layer made of SiO₂. A specific refractive index difference between a core and a clad layer of the silicon thin wire waveguide is about 40%, and light propagation in a minimum cross-sectional region of several 100 nm angles is possible in the vicinity of 1,550 nm which is a wavelength band used in single mode communication. Further, since an allowable bending radius of the silicon thin wire waveguide is as small as several μm, a complicated wiring pattern can be formed in a confined region.

The silicon thin wire waveguide is fabricated, using a well-known SOI (Silicon on Insulator) substrate. The SOI substrate includes a silicon support substrate, a buried silicon oxide layer (BOX layer) on the silicon support substrate, and a silicon active layer on the BOX layer. Such a silicon thin wire waveguide on the SOI substrate is formed, by forming the BOX layer as an under-clad layer, the silicon active layer as a waveguide shape to form a core, and further forming a quartz glass film as an over-clad layer on the core. Since the silicon thin wire waveguide can be fabricated on the SOI substrate, monolithic integration with an electronic circuit can be performed. From the viewpoint of the manufacturing technique, since a mature semiconductor microfabrication technique can be applied, a fine pattern can be easily formed. Therefore, by combining the silicon photonics technique with the semiconductor technique or the electronic circuit technique, it can be expected that optoelectronic integrated devices will be able to be realized.

However, the silicon thin wire waveguide having the above-mentioned features has a problem in terms of connection with other optical elements. That is, when connecting optical elements, it is important to match the mode field diameter (hereinafter referred to as “MFD”) of the light propagating in the optical elements to reduce the optical loss at the connection point. When the two optical elements are made to abut each other and connected, a coupling efficiency of the propagation light is determined by the overlap integration of the MFD of both of them. The MFD of the silicon optical circuit is about 300 nm. The silicon optical circuit is connected to a single mode fiber (hereinafter referred to as “SMF”) which is an optical transmission medium outside the silicon optical circuit. The MFD of a known SMF used also for long-distance transmission is about 9 μm. Further, the MFD of the SMF of a high specific refractive index difference design developed for connection with an optical waveguide or the like having a small MFD is about 4 μm. Therefore, the MFD of the silicon thin wire waveguide is smaller than the SMF by about 10 to 30 times, and there is a risk of an occurrence of a large coupling loss when both are directly connected.

As a method for solving the problem related to the connectivity between the silicon optical circuit and the SMF, it has been proposed to insert a spot size conversion (hereinafter referred to as “SSC”) structure. FIGS. 1(a), 1(b) and 1(c) are diagrams for explaining a known optical waveguide connection structure, and show an optical waveguide connection structure 600 included in a silicon optical circuit. FIG. 1(a) is a top view of an optical waveguide connection structure 600, FIG. 1(b) is a cross-sectional view taken along arrows Ib and Ib shown in FIG. 1(a), and FIG. 1(c) is a cross-sectional view taken along arrows Ic and Ic shown in FIG. 1(a). The optical waveguide connection structure 600 has a silicon optical waveguide 610 and a planar optical waveguide 620. The silicon optical waveguide 610 has a silicon core 603, and the planar optical waveguide 620 has an SiO₂ core 604. The optical waveguide connection structure 600 is provided with an SSC structure 630 to mitigate the influence of the difference of MFD between the silicon core 603 and the SiO₂ core 604. In FIGS. 1(a), 1(b) and 1(c), an axis along a direction in which the optical signal passes through the silicon optical waveguide 610 and the planar optical waveguide 620 is defined as a Z-axis, an axis orthogonal to the Z-axis and a surface of the support substrate 601 is defined as a Y-axis, and an axis orthogonal to the Z-axis and the Y-axis is defined as an X-axis. In the following description, a direction in which the Y-axis is directed from the support substrate 601 will be referred to as “upward”.

As shown in FIG. 1(b), the optical waveguide connection structure 600 includes, for example, a support substrate 601 made of silicon, an under-clad layer 602 formed on the support substrate 601, a silicon core 603 formed on the under-clad layer 602, an SiO₂ core 604 formed on the silicon core 603, and an over-clad layer 605 that covers the whole of each of the above-mentioned parts. The support substrate 601, the under-clad layer 602 and the silicon core 603 are manufactured by using an SOI substrate.

As is apparent from FIG. 1(a), the silicon core 603 includes a constant width part 603a having a constant length in an X-direction (hereinafter also referred to as “width”) and a narrow width part 603b having a reduced width along a Z-direction. The SiO₂ core 604 is formed to cover the narrow width part 603b, and the constant width part 603a is exposed from the SiO₂ core 604. The over-clad layer 605 covers the above-described configuration, and constitutes a clad layer of the optical waveguide connection structure 600 together with the under-clad layer 602. A specific refractive index difference between the under-clad layer 602 and the over-clad layer 605 and the SiO₂ core 604 is smaller than a specific refractive index difference between the under-clad layer 602 and the over-clad layer 605 and the silicon core 603.

Further, as is apparent from FIG. 1(a) or the like, a cross-sectional area of the cross-section intersecting an X-Y plane of the SiO₂ core 604 is larger than a cross-sectional area of the cross-section intersecting the X-Y plane of the silicon core 603. The MFD of the SiO₂ core 604 is larger than the MFD of the silicon core 603. Therefore, light incident from the constant width part 603a leaks to the surrounding under-clad layer 602 and the SiO₂ core 604 as it goes in the Z-direction through the narrow width part 603b. A transition process of the light is adiabatic, and theoretically, energy loss does not occur.

In the known optical waveguide connection structure 600, a quartz-based optical waveguide in which the SiO₂ core 604 is SiOₓ and the clad layer is SiO₂, or a polymer optical waveguide in which the SiO₂ core 604 and the clad layer are constituted of a polymer material is used. The specific refractive index difference of such a combination of materials is about 1% to several %. According to such a configuration, the cross-sectional area of about several 100 nm angles of the silicon core 304 is enlarged to the cross-sectional area of about several μm angles of the SiO₂ core 604, and the coupling efficiency with the SMF can be improved. Especially, when the optical waveguide including the SiO₂ core 604 is set as a quartz-based optical waveguide which is a quartz-based material similar to that of an optical fiber, the optical waveguide has low loss in a communication wavelength band, and a highly reliable, high-performance optical device with low temperature dependence and polarization dependence can be obtained.

A silicon photonics technique in which a silicon optical circuit and a planar optical waveguide are combined and two kinds of optical waveguides having different MFD are connected with a low loss is described, for example, in NPL 1.

### CITATION LIST

### Non Patent Literature

[NPL 1] R. Marchetti, C. Lacava, L. Carroll, K. Gradkowski, and P. Minzioni, “Coupling strategies for silicon photonics integrated chips,” Photonics Research, Vol. 7, Issue 2, pp. 201 to 239 (2019).

### SUMMARY OF INVENTION

However, the above-mentioned known configuration has problems in connection between the silicon optical waveguide 610 and the planar optical waveguide 620. That is, since the thickness of the silicon core 603 is several 100 nm and the thickness of the SiO₂ core 604 is several μm as shown in FIGS. 1(a) and 1(b), the centers do not coincide due to difference in the heights. When adiabatic coupling is utilized for light transition, perfect coupling is theoretically possible, even if the centers of the cores do not coincide with each other. However, the efficiency of adiabatic coupling depends on the dimensional accuracy of the silicon core 603 and the optical characteristics of the SiO₂ core 604. Therefore, all the optical energy is not always thermally coupled in all the parts to be manufactured.

When the adiabatic coupling is not performed, the remaining optical energy is butt-coupled with the SiO₂ core 604 at an end of the narrow width part 603b of the silicon core 603. In the butt coupling, since the coupling efficiency is determined by the overlap integration of the mode fields of the optical elements to be connected, the butt coupling efficiency may be deteriorated when the centers of the cores are different from each other.

In order to improve the butt coupling efficiency, is conceivable that a BOX layer of an SOI substrate used for manufacturing the optical waveguide connection structure 600 be cut by etching or the like, and the height of the SiO₂ core 604 be lowered to match the center height of the silicon core 603 and the SiO₂ core 604. However, the BOX layer to be the under-clad layer 602 needs to have a thickness (about 10 μm) so that the mode field of light propagating in the SiO₂ core 604 does not seep into the support substrate 601 or the like. Therefore, it is difficult to adopt a method for thinning the under-clad layer by etching or the like of the BOX layer.

Further, the SOI substrate having a BOX layer having a sufficient thickness even if it is cut by etching or the like is, for example, formed by the method shown in FIG. 2(a), FIG. 2(b), and FIG. 2(c). FIGS. 2(a), 2(b) and 2(c) are schematic cross-sectional views for explaining a method for manufacturing an SOI substrate having a thick BOX layer. In this method, first, as shown in FIGS. 2(a) and 2(b), the support substrate 701 is oxidized for a relatively long time to form a thermal oxide film 702 having a thickness of 10 μm or more. The formed thermal oxide film 702 functions as an under-clad layer of the completed optical waveguide. However, if the thermal oxide film 702 having a thickness of 10 μm or more is formed on the support substrate 701, the stress applied to the front and rear surfaces of the support substrate 701 becomes uneven, and a warpage occurs in the entire support substrate 701 at a stage shown in FIG. 2(b).

After the formation of the thermal oxide film 702, it is necessary to form a core layer 703 on the thermal oxide film 702 as shown in FIG. 2(c). However, since warpage occurs in the support substrate 701 as described above, it is difficult to bond single crystal silicon onto the thermal oxide film 702 and grind the single crystal silicon to about several 100 nm. Therefore, in forming the core layer 703, a technique of bonding the core layer of another SOI substrate to the silicon thermal oxide film 702 is effective. However, when the SOI substrates are bonded to each other, layers other than the necessary core layer are also integrated with one SOI substrate. In the example shown in FIG. 2(c), an oxide film 704 functioning as an under-clad layer of the other SOI substrate remains on the core layer 703. Removal of such as the oxide film 704 is carried out by grinding polishing, wet etching, or the like, and at this time, the core layer 703 may be damaged. The damage of the core layer 703 leads to the in-plane non-uniformity of the core layer 703, and hence deterioration of the processing accuracy of the silicon core.

The present disclosure has been made in view of the above-mentioned points, and relates to an optical waveguide connection structure capable of connecting two optical waveguides having mode fields significantly different in size with a low loss.

An aspect of the present disclosure to achieve the above object is an optical waveguide connection structure which connects a first optical waveguide and a second optical waveguide in one support substrate, the optical waveguide connection structure including: an under-clad layer formed on one surface of the support substrate; a ridge structure formed on a surface of the under-clad layer, on a side opposite to a side being in contact with the support substrate; a first optical waveguide core being in contact with the ridge structure; a pattern structure which is in contact with the first optical waveguide core, has a shape and a size coincident to those of the first optical waveguide core in a top view, and has a member having a lower refractive index than the first optical waveguide core as a material; a second optical waveguide core which covers the ridge structure, the pattern structure, and the first optical waveguide core, and is formed of a material having a refractive index lower than that of the first optical waveguide core and a refractive index higher than that of the under-clad layer; and an over-clad layer which is in contact with the second optical waveguide core, and is formed of a material having a refractive index lower than that of the second optical waveguide core.

According to the above-described configuration, it is possible to provide an optical waveguide connection structure capable of connecting two optical waveguides having mode fields significantly different in size with low loss.

### BRIEF DESCRIPTION OF DRAWINGS

FIG. 1 is a diagram for explaining a known SSC structure, FIG. 1(a) is a top view of a silicon optical circuit, FIG. 1(b) is a cross-sectional view of the silicon optical circuit of FIG. 1(a), and FIG. 1(c) is another cross-sectional view of the silicon optical circuit of FIG. 1(a).

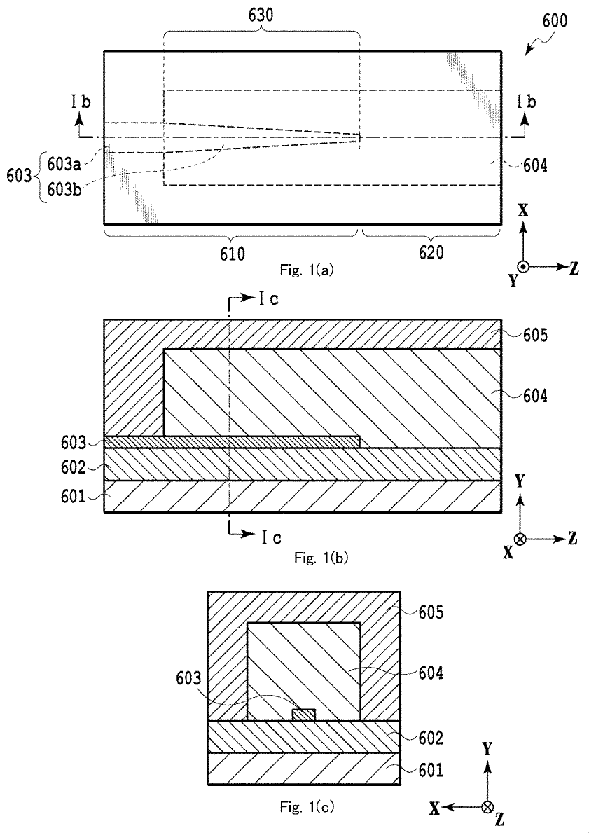

FIGS. 2(a), 2(b), and 2(c) are schematic cross-sectional views for explaining a known method for manufacturing an SOI substrate having a thick BOX layer.

FIG. 3 is a cross-sectional view for explaining a substrate of a first embodiment.

FIG. 4 is a diagram for explaining a method for manufacturing the substrate shown in FIG. 3.

FIG. 5(a) is a top view of an optical waveguide connection structure, and FIG. 5(b) is a cross-sectional view taken along an arrow line shown in FIG. 5(a).

FIG. 6(a) is a cross-sectional view taken along an arrow line shown in FIG. 5(b), FIG. 6(b) is a cross-sectional view taken along another arrow line, and FIG. 6(c) is a cross-sectional view taken along another arrow line.

FIGS. 7(a), 7(b), 7(c), and 7(d) are all process diagrams for explaining the method for manufacturing the optical waveguide connection structure of the first embodiment.

FIGS. 7(e), 7(f), 7(g), and 7(h) are process diagrams for explaining the method for manufacturing the optical waveguide connection structure of the first embodiment subsequent to FIG. 7A.

### DESCRIPTION OF EMBODIMENTS

Hereinafter, an optical waveguide connection structures of a first embodiment and a second embodiment of the present disclosure will be described below. The drawings referred to in the first embodiment and the second embodiment are intended to explain the configuration of the optical waveguide connection structure of the first embodiment and the second embodiment, arrangement, function, effect, and technical idea of each part, and do not limit specific shapes thereof. In addition, the drawings referred to in the first embodiment do not necessarily accurately represent the ratio of the longitudinal, lateral and thickness.

### First Embodiment

The optical waveguide connection structure of the first embodiment is manufactured using a substrate 100. In the first embodiment, first, the substrate 100 will be explained.

### Substrate

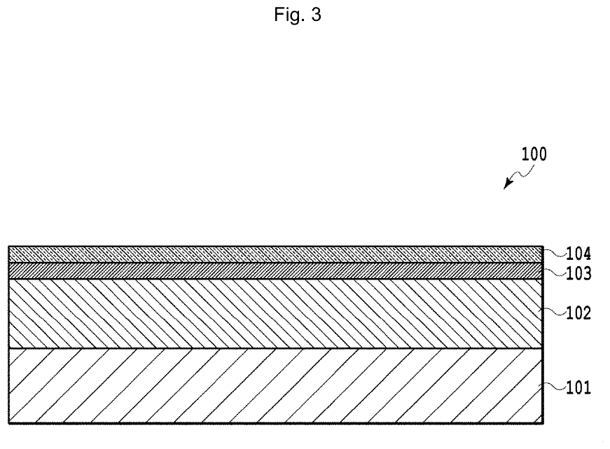

FIG. 3 is a cross-sectional view for explaining a substrate 100 of the first embodiment. The substrate 100 is an SOI substrate, and includes a support substrate 101 which is a first support substrate, an under-clad layer 102, a silicon core layer 103, and a glass layer 104 which is an insulating layer. In the first embodiment, the following description will be given with a side from the support substrate 101 side toward the glass layer 104 being “upward”. Therefore, the under-clad layer 102 is formed on the support substrate 101, the silicon core layer 103 is formed on the under-clad layer 102, and the glass layer 104 is formed on the silicon core layer 103, respectively. In the first embodiment, a length of each layer in a direction perpendicular to the support substrate 101 will be also referred to as “thickness” hereinafter.

A thickness of the under-clad layer 102 is preferably sufficiently thicker than a known thickness of the under-clad. In the first embodiment, the thickness of the under-clad layer 102 is set to 15 μm. The under-clad layer 102 is formed of a material having a refractive index smaller than that of the silicon core layer 103. Such a material is preferably a material containing quartz glass mainly including SiO₂, and for example, SiO₂, SiOₓ, a polymer and the like are adopted.

The thickness of the silicon core layer 103 may be within a range of the thickness of the core layer of a known silicon photonics circuit. This thickness may be, for example, about 0.2 μm to 1 μm. The silicon core layer 103 is made up of a material having a refractive index higher than that of the under-clad layer 102. As such a material, for example, Si, SiN, SiON, etc. can be used.

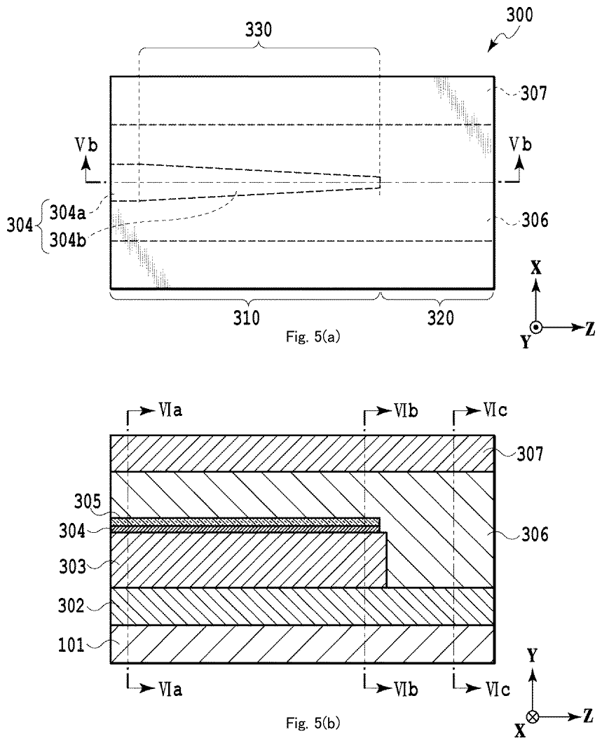

The thickness of the glass layer 104 may be, for example, about the thickness of the silicon core layer 103, and may be, for example, may be about 0.1 μm to 2 μm. The material of the pattern structure 305 (such as FIG. 5(a)) formed by the glass layer 104 may satisfy the material that has the refractive index lower than that of the silicon core layer 103, and is not removed in the process of removing the silicon core layer 103, but can be an etching mask when etching the silicon core layer 103 to form a silicon core. For example, SiO₂, SiOₓ or the like can be used as a material of the glass layer 104. The glass layer 104 using SiO₂ and SiOₓ as a material, that is, the pattern structure 204 (FIG. 5(a) or the like) can be a mask in etching the silicon core layer 103 of Si using SF₆. Here, “can be an etching mask” means that the glass layer 104 is not removed from the silicon core layer 103 until the etching of the silicon core layer 103 is completed, and does not damage the silicon core layer 103 under the pattern structure 305 (FIG. 5(a) or the like). Such a pattern structure 305 (FIG. 5(a) or the like) is also considered in thickness together with the material.

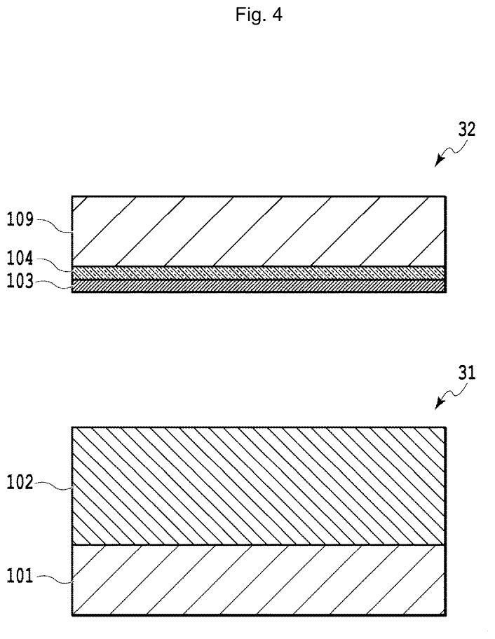

FIG. 4 is a diagram for explaining a method for manufacturing the substrate 100 shown in FIG. 3. In this description, an example is given in which the under-clad layer 102 is formed of SiO₂, the silicon core layer 103 is formed of Si, and the glass layer 104 is formed of SiO₂. The manufacturing of the substrate 100 includes a process of forming the under-clad layer 102, the silicon core layer 103, and the glass layer 104. The support substrate 101 on which the under-clad layer 102 is formed is preferably a silicon substrate, but may be a glass substrate.

The process of forming the under-clad layer 102 may be any method that can form the under-clad layer 102 having uniformity and smoothness capable of forming the silicon core layer 103 directly above the under-clad layer 102. The examples of such a method include a flame hydrolysis deposition method or the like. Alternatively, the support substrate 101 may be thermally oxidized to form the under-clad layer 102 of a thermally oxidized film. However, when an oxide film having a thickness of 10 μm or more is formed on the support substrate 101, stress is applied to the support substrate 101 due to unevenness of film formation amounts on the front and rear surfaces. A warpage occurs in the entire support substrate 101. It is difficult to bond single crystal silicon to the under-clad layer 102 of the warped support substrate 101 and grind the substrate to a desired thickness (about several 100 nm). Therefore, in the first embodiment, the silicon core layer 103 is formed as follows.

The process of forming the silicon core layer 103 on the under-clad layer 102 of the first embodiment is performed by bonding the SOI substrate 32 to the substrate 31 formed by the support substrate 101 and the under-clad layer 102. The SOI substrate 32 is a substrate that includes a support substrate 109 which is a second support substrate, a silicon core layer 103, and a glass layer 104 which is formed between the support substrate 109 and the silicon core layer 103 and uses a member having a refractive index smaller than that of the silicon core layer 103 as a material. The substrate 31 and the SOI substrate 32 are bonded so that the silicon core layer 103 is in contact with the under-clad layer 102.

The bonding may also be performed by a method for annealing at 1000° C. or higher to ensure a bonding strength after normal temperature bonding is performed to confirm the bonding state. Immediately after bonding, in addition to the silicon core layer 103, the glass layer 104 and the support substrate 109 of the SOI substrate 32 are in a state of being integrated with the substrate 31. In the first embodiment, among them, the support substrate 109 is removed by, for example, polishing.

After the support substrate is removed, the glass layer 104 may be removed by, for example, grinding polishing or wet etching. However, the removal of the glass layer 104 involves a risk of damaging or peeling the silicon core layer 103, and the damage or peeling may impair the in-plane uniformity of the silicon photonics circuit. In view of this point, in the first embodiment, at least a part of the glass layer 104 is left without being removed at the stage of manufacturing the substrate 100. In the first embodiment, only a part of the glass layer 104 is left on the silicon core layer 103, and the glass layer 104 may be cut to a desired thickness by wet etching or the like.

According to the above method, since the flat SOI substrate 32 is bonded to the substrate 31 warped by the formation of the under-clad layer 102, the warpage of the substrate 31 is corrected by the SOI substrate 32, and the silicon core layer 103 can be formed on the under-clad layer 102 in a flat state.

### Optical Waveguide Connection Structure

Next, an optical waveguide connection structure manufactured by using the above-mentioned substrate 100 will be described.

FIGS. 5(a) and 5(b) are diagrams for explaining the optical waveguide connection structure of the first embodiment, and show a silicon optical circuit including the optical waveguide connection structure 300. FIG. 5(a) is a top view of an optical waveguide connection structure 300, and FIG. 5(b) is a cross-sectional view taken along arrows Vb and Vb shown in FIG. 5(a). In the following description, an axis along a direction in which an optical signal passes through the silicon optical waveguide 310 and the SiO₂ optical waveguide 320 is defined as a Z-axis, an axis orthogonal to the Z-axis and the surface of the support substrate 101 is defined as a Y-axis, and an axis orthogonal to the Z-axis and the Y-axis is defined as an X-axis. In the present specification, a direction in which the Y-axis is directed from the support substrate 101 will be described as “upward”.

The optical waveguide connection structure 300 is an optical waveguide connection structure that connects the silicon optical waveguide 310 as a first optical waveguide and the SiO₂ optical waveguide 320 as a second optical waveguide in one support substrate 101. The silicon optical waveguide 310 is an optical waveguide in which a core is formed of single crystal silicon as a material. The SiO₂ optical waveguide 320 is an optical waveguide in which a core is made up of a material containing quartz glass with SiO₂ as a base material. The optical waveguide connection structure 300 includes an under-clad layer 302 formed on one surface of the support substrate 101, a ridge structure 303 formed on a surface of the under-clad layer 302 on an opposite side to the side being in contact with the support substrate 101, a silicon core 304 which is a first optical waveguide core being in contact with the ridge structure 303, and a pattern structure 305 which is in contact with the silicon core 304, has a shape and a size coincident with the silicon core 304 in a top view, and is made of a member having a refractive index lower than that of the silicon core 304 as a material.

The silicon core 304 includes a constant width part 304a having a constant width, and a narrow width part 304b having a width decreasing toward the Z-direction. Light passing through the narrow width part 304b leaks to an SiO₂ core 306 which is a core of the SiO₂ waveguide 320 as the width of the narrow width part 304b optical becomes smaller, and an optical signal flows between the silicon optical waveguide 310 and the SiO₂ optical waveguide 320. Such a configuration constitutes an SSC structure 330.

The optical waveguide connection structure 300 has an SiO₂ core 306 which is a second optical waveguide core that covers the ridge structure 303, the pattern structure 305 and the silicon core 304. The SiO₂ core 306 is formed of a material having a refractive index lower than that of the silicon core 304 and a refractive index higher than that of the under-clad layer 302. Further, the optical waveguide connection structure 300 has an over-clad layer 307 which is in contact with the SiO₂ core 306 and is formed of a material having a refractive index lower than that of the SiO₂ core 306.

FIGS. 5(a) and 5(b) show only a part of an optical circuit in which the silicon optical waveguide 310 and the SiO₂ optical waveguide 320 are integrated one by one on the support substrate 101. The number of the silicon optical waveguides 310 and the SiO₂ optical waveguides 320 is not limited thereto, and may include more silicon optical waveguides 310 and SiO₂ optical waveguides 320. The optical waveguide is not limited to the silicon optical waveguide 310 and the SiO₂ optical waveguide 320, and may include an optical waveguide of other configuration.

Here, the refractive index of the silicon core 304 is set as n1, the refractive index of the SiO₂ core 306 is set as n2, and the refractive index of the under-clad layer 302 is set as n3. The material constituting the silicon optical waveguide 310 and the SiO₂ optical waveguide 320 may satisfy following relationship:

$$n 1 > n 2 > n 3 \qquad Equation ( 1 )$$

In the description of the first embodiment, the description will be given of a case in which the silicon core 304 is Si, the SiO₂ core 306 is SiO₂, and the under-clad layer 302 is SiO₂ having a refractive index lower than that of the SiO₂ core 306. However, the first embodiment is not limited to the use of such materials, and for example, the silicon core 304 may be SiN or SiON, and the SiO₂ core 306 may be SiOₓ. The core of the second optical waveguide may be a polymer. In the first embodiment, the materials and refractive indices of the over-clad layer 307 and the under-clad layer 302 may be the same, but they need not be strictly the same. That is, the over-clad layer 307 is made up of a material that satisfies the following Equation (2) together with the above Equation (1) when the refractive index is set as n4.

$$n 1 > n 2 > n 4 \qquad Equation ( 2 )$$

In the first embodiment, the pattern structure 305 is formed by etching the glass layer 104. However, the material of the pattern structure 305 may be a material which has a refractive index lower than that of the silicon core 304 and is not removed when the silicon core 304 is removed. The material of the pattern structure 305 may be SiO₂, SiOₓ or the like. Such a material can be a mask in etching using SF₆ when the material of the silicon core 304 is Si. Here, “can be a mask for etching” means that the patterned structure 305 is a material which is not removed from top of the silicon core 304 until the etching for forming the silicon core 304 is completed and does not damage the silicon core 304 under the patterned structure 305. The thickness of the pattern structure 305 as well as the material is also considered.

The ridge structure 303 is formed of the same material as that of the under-clad layer 302, that is, SiO₂, SiOₓ, a polymer or the like. The width of the ridge structure 303 may be equal to or larger than the width of the silicon core 304 and less than the width of the SiO₂ core 306. The thickness of the ridge structure 303 is preferably approximately equal to a thickness obtained by subtracting ½ of the thickness of the silicon core 304 from ½ of the thickness of the SiO₂ core 306. Here, the degree of “approximate” depends on the controllability of the film formation of the SiO₂ core 306 and the silicon core 304, and for example, the difference in the range of ±1 μm is allowed.

### Core Size, MFD in Case of Single Mode

Both the silicon optical waveguide 310 and the SiO₂ optical waveguide 320 have no upper limit on the size (hereinafter simply referred to as “size”) of a cross-section intersecting an X-Y plane, a multimode optical waveguide for propagating light of a plurality of modes can be used in the wavelength band of light used as a signal. Further, by reducing the size of the cross-section of the core, a single mode optical waveguide for propagating only the lowest order mode can be provided. In the silicon optical waveguide 310, the silicon core 304 functions as a core, and the SiO₂ core 306 and the ridge structure 303 function as a clad layer. Although the pattern structure 305 can be said as a residue of etching of the silicon core 305, the pattern structure 305 functions as a part of an over-clad layer in the related silicon waveguide 310. Such a silicon optical waveguide 310 has a relatively large refractive index difference between the core and the clad layer, and in the case of a single mode, the size of the silicon core 304 can be reduced to several hundreds of nanometers square.

In the SiO₂ optical waveguide 320, the SiO₂ core 306 functions as a core, and the under-clad layer 302 and the over-clad layer 307 function as clad layers. In such a configuration, since SiO₂ is used for both the core and the clad, the refractive index difference between the core and the clad layer is smaller than that of the silicon optical waveguide 310. In the case of a single mode, the size of the cross-section of the SiO₂ core 306 is from several μm angles to about 10 μm angles.

As mentioned above, the silicon optical waveguide 310 and the SiO₂ optical waveguide 320 have a difference of up to 100 times in the size of the cross-section of the core. Therefore, the MFD of the light propagating in the SiO₂ core 306 becomes remarkably larger than the MFD of the light propagating in the silicon core 304.

### Spot Size Conversion

In order to connect the silicon optical waveguide 310 and the SiO₂ optical waveguide 320 of different MFD, the first embodiment includes an SSC structure 330 as shown in FIG. 5(a), and gradually enlarges the MFD propagating in the silicon core 304. Such a function of the SSC structure 330 is realized by the narrow width part 304b of the silicon core 304. The narrow width part 304b is not limited to a narrow width part which becomes smaller in the width direction toward the Z-direction, and, for example, may be configured to become smaller in the Y-direction, that is, to become lower in the Z-direction. The structure which becomes thinner in the Z-direction is also referred to as a tapered structure. The SSC structure can also be realized by a segmented structure in which the silicon core 304 is divided in the light propagation direction, that is, a region in which the core is formed and a region in where the core is not formed are alternately repeated. The SSC structure of the first embodiment may be a structure in which the tapered shape and the segmented structure are combined.

### Connection Loss

Next, the configuration for reducing the coupling loss of the first embodiment will be described. The first embodiment includes an SSC structure 330 as shown in FIG. 5(a), and adiabatically transitions light passing through the silicon core 304 to the SiO₂ core 306. However, in such coupling, a part of the optical energy may not be thermally coupled. The optical energy, which has not been thermally coupled, propagates in the silicon core 304, reaches an interface between the silicon optical waveguide 310 and the SiO₂ optical waveguide 320, and is butt-coupled with the SiO₂ core 306 at the interface. The coupling efficiency of the butt coupling becomes higher, as the butt coupling efficiency defined by the overlap integration of the MFD of the silicon core 304 and the MFD of the SiO₂ core 306 is higher at the boundary between the silicon optical waveguide 310 and the SiO₂ optical waveguide 320. In the first embodiment, the height of the silicon core 304 is adjusted in accordance with the center of the SiO₂ core 306 by providing the ridge structure 303, and the overlapped part of the MFD of both is enlarged.

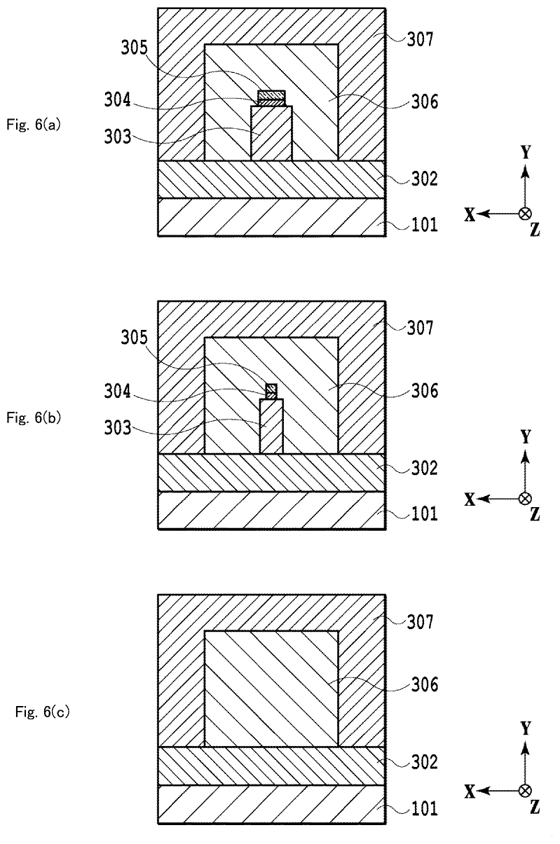

FIGS. 6(a), 6(b) and 6(c) are cross-sectional views taken along the arrow shown in FIG. 5(b). FIG. 6(a) is a cross-sectional view taken along arrows VIa and VIa, FIG. 6(b) is a cross-sectional view taken along arrows VIb and VIb, and FIG. 6(c) is a cross-sectional view taken along arrows VIc and VIc. As shown in FIGS. 6(a), 6(b) and 6(c), the silicon optical waveguide 310 has the largest width of the silicon core 304 in a cross-section along the arrows VIa and VIa, and the width of the silicon core 304 is reduced in the cross-section along the arrows VIb and VIb. In a cross-section along the arrows VIc, VIc, the waveguide of the optical waveguide connection structure 300 is an SiO₂ optical waveguide 320. As shown in FIG. 6(a) and FIG. 6(b), the silicon core 304 is disposed near the center of the SiO₂ core 306 by being formed on the ridge structure 303.

In order to increase the overlap area of the MFD of the silicon core 304 and the SiO₂ core 306, in the first embodiment, the thickness of the ridge structure 303 is made to coincide with the thickness obtained by subtracting ½ of the thickness of the silicon core 304 from ½ of the thickness of the SiO₂ core. Thus, the center of the silicon core 304 formed on the upper surface of the ridge structure 303 coincides with the center of the SiO₂ core.

As described above, in the first embodiment, the center heights of the silicon core 304 and the SiO₂ core 306 are made to coincide with each other, the butt coupling efficiency defined by the overlap integration of the mode field is increased, and the optical energy can be coupled with a low loss.

### Manufacturing Method

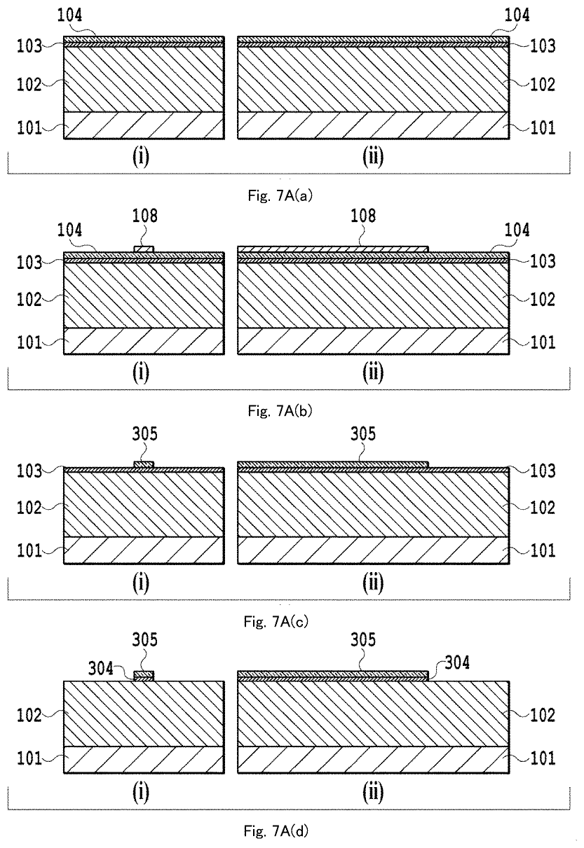

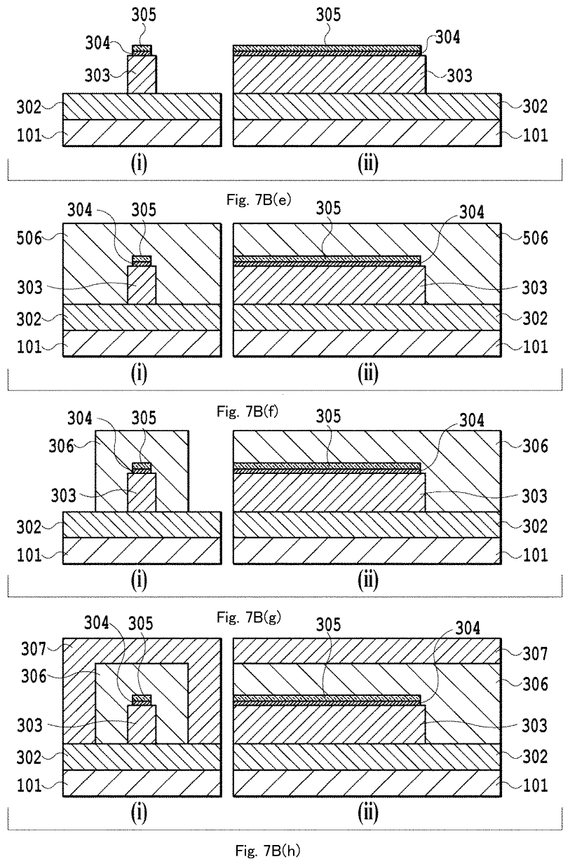

Next, a method for manufacturing the optical waveguide connection structure 300 described above will be described. FIGS. 7A(a) to 7B(h) are cross-sectional views for explaining a method for manufacturing the optical waveguide connection structure 300. In each drawing, (i) is a cross-sectional view taken along arrows VIa and VIa in FIG. 5(b), and (ii) is a cross-sectional view taken along arrows Vb and Vb in FIG. 5(a). In manufacturing the optical waveguide connection structure 300, as first, shown in FIG. 7A(a), the substrate 100 shown in FIG. 3 is manufactured. Next, in the first embodiment, as shown in FIG. 7A(b), a protective film pattern 108 is formed immediately above the glass layer 104. The protective film pattern 108 may be formed by a known photolithography technique using an electron beam lithography device, a reduction projection exposure device, or the like.

Next, in the first embodiment, as shown in FIG. 7A(c), the glass layer 104 is etched using the protective film pattern 108 as a mask to form the pattern structure 305. In the first embodiment, as shown in FIG. 7A(d), the silicon core layer 103 is etched using the pattern structure 305 as a mask. As a result of the etching, the silicon core 304 capable of propagating light is formed. By forming the silicon core 304 in this manner, the pattern structure 305 and the silicon core 304 have the shape and size that coincide in a top view. However, “the shape and size coincide in the top view” may be determined by visual observation via a microscope or the like, and for example, a difference such that the corner portion of the pattern structure 305 is rounded more than the corner portion of the silicon an core 304 by over-etching is allowed. In the first embodiment, optical circuit of silicon photonics may be formed in addition to the formation of the silicon core 304.

In the process described above, the first embodiment does not need to remove all the glass layer 104 which is the uppermost layer of the substrate 100 shown in FIG. 3, and can be used as a hard mask when processing the silicon core 304. Thus, it is possible to prevent deterioration of in-plane uniformity of the silicon core layer 103 due to removal of the glass layer 104, and finally, the silicon core 304 can be processed with high accuracy.

Next, in the first embodiment, as shown in FIG. 7B(e), the ridge structure 303 and the under-clad layer 302 are formed by processing the under-clad layer 102. The under-clad layer 102 has a thickness of about 15 μm. Therefore, even after the ridge structure 303 is formed, the under-clad layer 302 can maintain a thickness sufficient to exhibit a function as an under-cladding that does not leak out a mode field of a core of about several μm. Next, in the first embodiment, as shown in FIG. 7B(f), an SiO₂ layer 506 is formed from above the ridge structure 303, the silicon core 304 and the pattern structure 305. As shown in FIG. 7B(g), the SiO₂ layer 506 is processed so that light can be propagated as a waveguide core, and becomes the SiO₂ core 306. At this time, the SiO₂ core 306 is preferably wider than the silicon core 304 and the pattern structure 305 which are previously processed. This is to avoid the influence of the silicon core 304 and the side wall of the pattern structure 305 which are previously processed when the SiO₂ core 306 is processed.

Furthermore, in the first embodiment, as shown in FIG. 7B(h), an over-clad layer 307 made of SiO₂ having a lower refractive index than the SiO₂ core 306 is formed. The optical waveguide connection structure 300 of the first embodiment is completed by the processes described above.

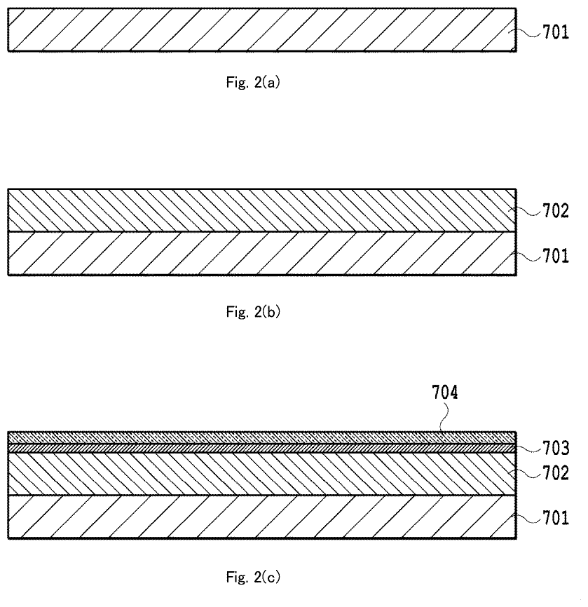

Other effects of the first embodiment will be described with reference to FIGS. 2 and 3. The connection loss between the silicon optical waveguide 310 and the SiO₂ optical waveguide 320 depends on the dimensional accuracy of the silicon core 304 in the SSC structure 330. For example, as shown in FIG. 5(a), when the SSC structure 330 is formed into a tapered shape which becomes narrower in the Z-axis direction, it is desirable that the width of the tip of the silicon core 304 be sufficiently narrow. In order to process the tip of the silicon core 304 sufficiently thin, there is a method for forming the protective film pattern 108 shown in FIG. 7A(b) so that the width thereof becomes the minimum width, and then processing the protective film pattern so that the width thereof becomes lower than a lower limit value of the width of the formable protective film pattern 108.

As the above-mentioned method, for example, a reactive ion etching method using oxygen gas or the like is used. At this time, in the first embodiment, since the silicon core layer 103 is covered with the glass layer 104, the surface of the silicon core layer 103 is not damaged by the etching gas injection. That is, the silicon core 304 in the SSC structure 330 can be finally processed with high accuracy without impairing the in-plane uniformity of the silicon core layer 103, and the connection loss between optical waveguides having different mode field sizes can be reduced.

### Second Embodiment

Next, a second embodiment of the present disclosure will be described. In the second embodiment, the refractive indices of the pattern structure 305 and the ridge structure 303 are made equal to each other, and the asymmetry of the mode field is eliminated. The second embodiment differs from the first embodiment in this respect, and the shape thereof is the same as that of the first embodiment. Therefore, the second embodiment will be described with reference to FIGS. 5(a) and 5(b).

In the second embodiment, the ridge structure 303 and the pattern structure 305 are made of the same material. The same material may be, for example, SiO₂, SiOₓ, or the like. The ridge structure 303 and the pattern structure 305 have substantially the same refractive index. Here, the “substantially same” refractive index permits the difference in refractive index originating from the manufacturing in the same material.

Since the refractive indices of the ridge structure 303 and the pattern structure 305 are substantially the same, the refractive indices of the over-clad layer and the under-clad layer of the silicon core 304 become substantially the same. As a result, the silicon core 304 has a mode field which is line-symmetrical in a vertical direction (substrate vertical direction) with respect to a virtual plane through which a central axis of the silicon core 304 passes. Since both sides of the silicon core 304 on the X-Z plane are SiO₂ cores 306, the refractive indexes of the silicon core 304 in the right and left (substrate horizontal direction) are also symmetrical. That is, in the second embodiment, the mode field of the silicon core 304 can be made line-symmetrical with respect to a horizontal direction (substrate horizontal direction) with respect to the central axis.

Further, since all the peripheral clads (under-clad layer 302 and over-clad layer 307) have the same refractive index, the SiO₂ core 306 has a mode field which is line-symmetrical with respect to both the vertical direction (substrate vertical direction) and the horizontal direction (substrate horizontal direction). In the second embodiment, as described above, the mode field of the silicon core 304 is line-symmetrical, the butt coupling efficiency defined by the overlap integration of the mode fields of both is increased, and the optical energy coupling having a lower loss than that of the first embodiment is realized.

### REFERENCE SIGNS LIST

31 Substrate
32 SOI substrate
100 Substrate
101, 109 and 601 Support substrate
102 Under-clad layer
103 Silicon layer
104 Glass layer
108 Protective film pattern
300, 600 Optical waveguide connection structure
302, 602 Under-clad layer
303 Ridge structure
304, 603 Silicon core
304a, 603a Constant width part
304b, 603b Narrow width part
305 Pattern structure
306 to 604 SiO₂ core
307, 605 Over-clad layer
310, 610 Silicon optical waveguide
320 SiO₂ Optical waveguide
330, 630 Spot size converter
506 SiO₂ layer
620 Planar optical waveguide

1. An optical waveguide connection structure which connects a first optical waveguide and a second optical waveguide in one support substrate, the optical waveguide connection structure comprising:
an under-clad layer formed on one surface of the support substrate;
a ridge structure formed on a surface of the under-clad layer, on a side opposite to a side being in contact with the support substrate;
a first optical waveguide core being in contact with the ridge structure;
a pattern structure which is in contact with the first optical waveguide core, has a shape and a size coincident to those of the first optical waveguide core in a top view, and has a member having a lower refractive index than the first optical waveguide core as a material;
a second optical waveguide core which covers the ridge structure, the pattern structure, and the first optical waveguide core, and is formed of a material having a refractive index lower than that of the first optical waveguide core and a refractive index higher than that of the under-clad layer; and
an over-clad layer which is in contact with the second optical waveguide core, and is formed of a material having a refractive index lower than that of the second optical waveguide core.

2. The optical waveguide connection structure according to claim 1,
wherein a material of the pattern structure is a material that is not removed when etching for forming the first optical waveguide core, and is able to serve as a mask for forming the first optical waveguide core.

3. The optical waveguide connection structure according to claim 1,
wherein the ridge structure has a thickness approximately equal to a thickness obtained by subtracting ½ of the thickness of the core of the first optical waveguide from ½ of the thickness of the core of the second optical waveguide, and
a height of a center of the core of the first optical waveguide coincides with a height of a center of the core of the second optical waveguide.

4. The optical waveguide connection structure according to claim 1,
wherein the first optical waveguide and the second optical waveguide are single-mode waveguides with respect to a wavelength of an optical signal to be guided.

5. The optical waveguide connection structure according to claim 1, further comprising:
a spot size converter which changes a mode field diameter of an optical signal propagating through the first optical waveguide at an interface between the first optical waveguide and the second optical waveguide.

6. The optical waveguide connection structure according to claim 5,
wherein the spot size converter includes at least one of a structure in which a diameter of the first optical waveguide changes into a tapered shape in a horizontal plane or a vertical plane, and a structure in which a core of the first optical waveguide is intermittently formed.

7. The optical waveguide connection structure according to claim 1,
wherein the ridge structure and the pattern structure are made of materials having refractive indices equal to each other.

8. The optical waveguide connection structure according to claim 1, wherein the core of the first optical waveguide includes single crystal silicon, and the under-clad layer, the ridge structure, the pattern structure, the core of the second optical waveguide, and the over-clad layer include quartz glass having SiO₂ as a base material.

9. The optical waveguide connection structure according to claim 2,
wherein the ridge structure has a thickness approximately equal to a thickness obtained by subtracting ½ of the thickness of the core of the first optical waveguide from ½ of the thickness of the core of the second optical waveguide, and
a height of a center of the core of the first optical waveguide coincides with a height of a center of the core of the second optical waveguide.

10. The optical waveguide connection structure according to claim 2,
wherein the first optical waveguide and the second optical waveguide are single-mode waveguides with respect to a wavelength of an optical signal to be guided.

11. The optical waveguide connection structure according to claim 2,
wherein the ridge structure and the pattern structure are made of materials having refractive indices equal to each other.

12. The optical waveguide connection structure according to claim 2, wherein the core of the first optical waveguide includes single crystal silicon, and the under-clad layer, the ridge structure, the pattern structure, the core of the second optical waveguide, and the over-clad layer include quartz glass having SiO₂ as a base material.
